(19) United States
(12) Patent Application Publication
(10) Pub. No.: US 2025/0124943 A1
(43) Pub. Date: Apr. 17, 2025

(54) WAVEFORM SIGNAL GENERATION SYSTEM, WAVEFORM SIGNAL GENERATION METHOD AND PROGRAM

(71) Applicant: NIPPON TELEGRAPH AND TELEPHONE CORPORATION, Tokyo (JP)

(72) Inventors: Takuhiro KANEKO, Musashino-shi (JP); Ko TANAKA, Musashino-shi (JP); Hirokazu KAMEOKA, Musashino-shi (JP); Shogo SEKI, Musashino-shi (JP)

(73) Assignee: NIPPON TELEGRAPH AND TELEPHONE CORPORATION, Tokyo (JP)

(21) Appl. No.: 18/834,049

(22) PCT Filed: Feb. 10, 2022
(86) PCT No.: PCT/JP2022/005433

§ 371 Date: Jul. 29, 2024

(51) Int. Cl. G10L 25/30; G10L 13/02; G10L 21/003

(52) U.S. Cl. CPC G10L 25/30; G10L 13/02; G10L 21/003

(57) ABSTRACT

A waveform signal generation system includes: a neural network function unit configured to generate a target waveform signal from an intermediate representation signal by changing a time component or a feature component of the intermediate representation signal indicating an intermediate representation between an input signal and the target waveform signal using a neural network function; and a non-neural network function unit configured to act for at least a part of processing for generating the target waveform signal from the intermediate representation signal using a non-neural network function indicating a relationship between the time component and the feature component of the intermediate representation signal. The neural network function unit upsamples a time component of the intermediate representation signal using the neural network function.

### TECHNICAL FIELD

The present invention relates to a waveform signal generation system, a waveform signal generation method, and a program.

### BACKGROUND ART

In communication, voice is one of the most frequently used types of media information. Therefore, research on text voice synthesis and voice transformation has actively been carried out in order to smooth communication. The following processes of first and the second stages are often used as processes of text voice synthesis and voice transformation. Hereinafter, a signal indicating an intermediate representation between an input signal and a target waveform signal is referred to as an “intermediate representation signal”.

### First Stage Process:

In voice transformation, an intermediate representation prediction device generates an intermediate representation related to an input waveform signal (input waveform signal). An intermediate representation prediction device predicts an intermediate representation signal related to a waveform signal which is a restoration target (hereinafter referred to as “target waveform signal”) based on an intermediate representation related to an input waveform signal. In the text voice synthesis, text data is input to the intermediate representation prediction device instead of inputting the waveform signal to the intermediate representation prediction device.

In the first stage process, a feature obtained by applying a time-frequency transform based on a predetermined basis function such as a short-time Fourier transform or a wavelet transform to an input waveform signal, or a feature obtained by linearly transforming the feature, is frequently used as an intermediate representation signal related to the target waveform signal. The feature is, for example, a spectrogram or a mel spectrogram. Features (cepstrum or mel cepstrum) obtained by further Fourier transform of the spectrogram or mel spectrogram are also often used as intermediate representation signals.

Further, a feature further obtained by applying a predetermined function to an input waveform signal or the obtained feature is often used as an intermediate representation signal. The predetermined function is, for example, a neural network function.

### Second Stage Process:

A waveform signal generation device generates a target waveform signal based on an intermediate representation signal related to the target waveform signal.

As a method for implementing the foregoing second stage process, a scheme using a neural network has attracted attention. For example, in a scheme based on a generic adversarial network (GAN), a 1-dimensional convolutional neural network is trained using a hostile learning scheme. The waveform signal generation device generates a target waveform signal by inputting a mel spectrogram to a model that has a trained neural network (trained model) (see NPD 1).

A waveform signal generation device that includes a high-performance graphics processing unit (GPU) and a large-capacity memory generates a target waveform signal in a sufficiently short time (real time), compared with a speech speed, by using such a trained model. A deep neural network (DNN) is often used for such a trained model. A neural network such as a deep neural network has many learning parameters.

### CITATION LIST

### Non Patent Document

[NPD 1] Jungil Kong, Jaehyeon Kim, Jaekyoung Bae, “HiFi-GAN: Generative Adversarial Networks for Efficient and High Fidelity Speech Synthesis”, in Adv. NeurIPS, 2020.

### SUMMARY OF INVENTION

### Technical Problem

However, a trained model that has many learning parameters (a trained model of which a weight is not reduced or a speed is not increased) cannot be operated by a waveform signal generation device that includes no large-capacity memory. A trained model requiring many types of arithmetic processing cannot be operated by a waveform signal generation device that includes no high-speed arithmetic processing function. Therefore, when a target waveform signal is generated from the intermediate representation signal using a trained model that has a neural network, it is desirable to reduce a weight and increase a speed in advance in the trained model.

In view of the foregoing circumstances, an object of the present invention is to provide a waveform signal generation system, a waveform signal generation method, and a program capable of reducing a weight or increasing speed of a trained model in advance when a target waveform signal is generated from an intermediate representation signal using the trained model that has a neural network.

### Solution to Problem

According to an aspect of the present invention, a waveform signal generation system includes: a neural network function unit configured to generate a target waveform signal from an intermediate representation signal by changing a time component or a feature component of the intermediate representation signal indicating an intermediate representation between an input signal and the target waveform signal using a neural network function; and a non-neural network function unit configured to act for at least a part of processing for generating the target waveform signal from the intermediate representation signal using a non-neural network function indicating a relationship between the time component and the feature component of the intermediate representation signal.

According to another aspect of the present invention, a waveform signal generation method executed by a waveform signal generation system includes: a step of generating a target waveform signal from an intermediate representation signal by changing a time component or a feature component of the intermediate representation signal indicating an intermediate representation between an input signal and the target waveform signal using a neural network function; and a step of acting for at least a part of processing for generating the target waveform signal from the intermediate representation signal using a non-neural network function indicating a relationship between the time component and the feature component of the intermediate representation signal.

According to still another aspect of the present invention, a program causes a computer to function as the foregoing waveform signal generation system.

### Advantageous Effects of Invention

According to the present invention, when a target waveform signal is generated from an intermediate representation signal using a trained model that has a neural network, a weight can be reduced and a speed can be increased in advance in the trained model.

### BRIEF DESCRIPTION OF DRAWINGS

FIG. 1 is a diagram illustrating a configuration example of a waveform signal generation system according to an embodiment.

FIG. 2 is a diagram illustrating a configuration example of another waveform signal generation device which is a comparison target with the waveform signal generation device according to the embodiment.

FIG. 3 is a diagram illustrating a configuration example of the waveform signal generation device according to the embodiment.

FIG. 4 is a flowchart illustrating an operation example of the waveform signal generation device according to the embodiment.

FIG. 5 is a diagram illustrating examples of advantageous effects of the waveform signal generation device according to the embodiment.

FIG. 6 is a diagram illustrating a hardware configuration example of the waveform signal generation system according to the embodiment.

### DESCRIPTION OF EMBODIMENTS

### (Overview)

As the foregoing second stage process, the waveform signal generation device generates a target waveform signal (for example, a voice waveform signal) corresponding to one or more intermediate representation signals input from the intermediate representation prediction device by using a waveform signal generation method by which a speed is increased and a weight is reduced. Accordingly, the waveform signal generation device restores a signal (input signal) input to the intermediate representation prediction device as the target waveform signal.

The waveform signal generation device includes a trained model that includes a neural network function unit and a non-neural network function unit. The neural network function unit has learning parameters. For example, the neural network function unit has a 1-dimensional convolution neural network.

On the other hand, the non-neural network function unit has no learning parameters. The non-neural network function unit is a function unit that executes predetermined signal processing. The predetermined signal processing is, for example, frequency-time transformation based on a predetermined basis function such as an inverse short-time Fourier transform or an inverse wavelet transform.

Since the trained hybrid model has fewer number of learning parameters than the trained model including only the neural network function unit, the weight of the model is reduced. The waveform signal generation device generates the target waveform signal from the intermediate representation signal by using the trained model in which the weight is reduced more than the trained model including only the neural network.

Hereinafter, a feature compressed in a time direction is used as an intermediate representation signal related to the target waveform signal. The feature compressed in the time direction is, for example, a spectrogram, a mel spectrogram, a cepstrum, or a mel cepstrum. The feature compressed in the time direction may be a feature obtained as a result obtained by applying a function for downsampling in the time direction to the voice waveform signal.

When the feature compressed in the time direction is returned to the target waveform signal (voice waveform signal), it is necessary to perform upsampling in the time direction. In particular, when upsampling is performed in multiple stages, a length in the time direction becomes longer and a processing amount increases at a rear stage (output side) in the second stage process. Therefore, when the non-neural network is used in the rear stage of the second stage process, it is easy to increase a speed of the processing for generating the target waveform signal.

Accordingly, in the second stage process at a front stage, the waveform signal generation device uses a neural network. That is, the neural network function unit performs a part of the processing for upsampling in the time direction. At the rear stage of the second stage process, the waveform signal generation device uses predetermined signal processing. That is, the non-neural network function unit performs the remaining part of the processing for upsampling in the time direction.

Here, the neural network function unit sufficiently reduces a gap between the input intermediate representation signal and the intermediate representation signal required for the input of the non-neural network function unit by performing upsampling. The non-neural network function unit performs predetermined signal processing (for example, a frequency-time transformation based on a predetermined basis function such as an inverse short-time Fourier transform or an inverse wavelet transform) on the remaining part of the upsampling process in the time direction.

In this way, when the target waveform signal (voice waveform signal) is generated from the intermediate representation signal, some layers of the neural network in the trained model are replaced in advance with a non-neural network function unit in which a speed is increased or a weight is reduced. Accordingly, it is possible to increase a speed of generation processing for the target waveform signal. Since the number of learning parameters is reduced, a size of the trained model is reduced.

A hybrid signal processing unit of the neural network function unit and the non-neural network function unit can be used to make generation processing of the target waveform signal with sufficient representation power efficient. While the quality of the target waveform signal is kept at a given level or higher, it is possible to achieve an increase in the speed and a reduction in the weight of the generation processing for the target waveform signal.

An embodiment of the present invention will be described in detail with reference to the diagrams.

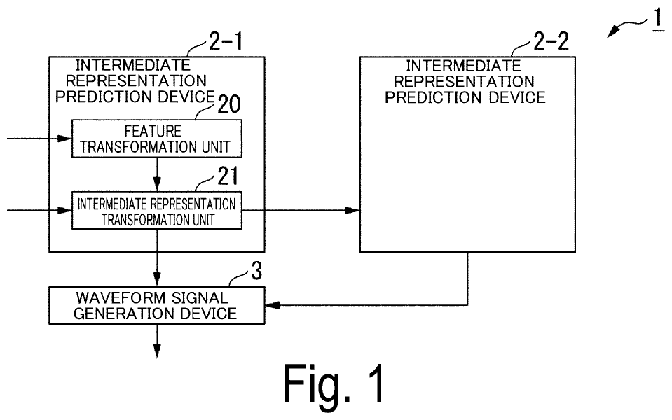

FIG. 1 is a diagram illustrating a configuration example of the waveform signal generation system 1 according to the embodiment. The waveform signal generation system 1 (signal processing system) is a system that generates a waveform signal (target waveform signal) such as a voice waveform signal.

The waveform signal generation system 1 includes an intermediate representation prediction device 2-1 and a waveform signal generation device 3. The intermediate representation prediction device 2 includes a feature transformation unit 20 and an intermediate representation transformation unit 21.

When a voice waveform signal is generated using a neural network function, an intermediate representation of the voice waveform signal is used to mitigate difficulty of transformation (text voice synthesis) from text to voice waveform signal or mitigate difficulty of direct transformation (voice transformation) from voice waveform signal to a voice waveform signal. In general, a representation which is more abstract than a voice waveform signal is used as an intermediate representation. The representation which is more abstract than the voice waveform signal is, for example, information compressed (aggregated) in a time direction, information dimensionally compressed in a frequency direction, or information from which a phase component is removed (information of which a phase is dropped out). In this way, various representations may be used as the intermediate representation of the voice waveform signal.

Hereinafter, a case where a mel spectrogram is used as an example of the intermediate representation will be described. In the first stage process, the mel spectrogram is derived through processing described below (S1), (S2) and (S3).
(S1): The feature transformation unit 20 extracts features (amplitude spectrogram and phase spectrogram) from the voice waveform signal by applying a short-time Fourier transform to the input signal (voice waveform signal).
(S2): The intermediate representation transformation unit 21 excludes a phase spectrogram between the extracted amplitude spectrogram and phase spectrogram from the feature.
(S3): The intermediate representation transformation unit 21 transforms the feature (amplitude spectrogram) from which the phase spectrogram is removed into a mel scale. The intermediate representation transformation unit 21 outputs the mel spectrogram as an intermediate representation signal to the waveform signal generation device 3.

The waveform signal generation device 3 generates a target waveform signal based on the mel spectrogram (intermediate representation signal) input from the intermediate representation prediction device 2 by using a hybrid trained model of the neural network and the non-neural network. The non-neural network function is a function of frequency-time transformation based on, for example, the predetermined basis function such as an inverse short-time Fourier transform or an inverse wavelet transform.

The waveform signal generation system 1 may be a system that performs text voice synthesis. In this case, since the intermediate representation is directly derived from the text, the intermediate representation prediction device 2 may include the intermediate representation transformation unit 21 and may not include the feature transformation unit 20. Accordingly, the intermediate representation transformation unit 21 acquires text. The intermediate representation transformation unit 21 outputs an intermediate representation of the target voice to the waveform signal generation device 3.

The waveform signal generation system 1 may be a system that performs the voice transformation. In this case, the waveform signal generation system 1 includes an intermediate representation prediction device 2-1, an intermediate representation prediction device 2-2, and the waveform signal generation device 3. The feature transformation unit 20 of the intermediate representation prediction device 2-1 acquires an input voice. The intermediate representation transformation unit 21 of the intermediate representation prediction device 2-1 outputs the intermediate representation of the input voice to the intermediate representation prediction device 2-2. The intermediate representation transformation unit 21 of the intermediate representation prediction device 2-2 outputs an intermediate representation of the target voice to the waveform signal generation device 3.

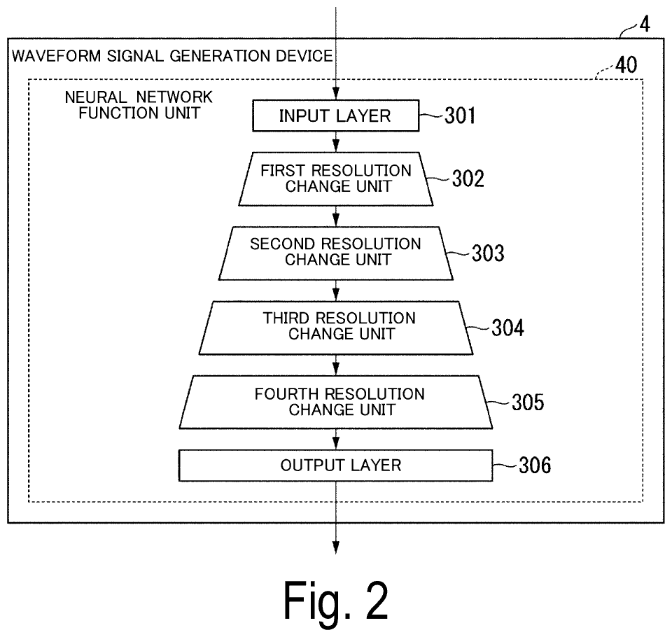

FIG. 2 is a diagram illustrating a configuration example of another waveform signal generation device which is a comparison target (comparison example) with the waveform signal generation device 3 according to the embodiment. The waveform signal generation device 4 includes a neural network function unit 40.

The waveform signal generation device 4 is a comparison target (comparison example) exemplified to simplify description of the configuration of the waveform signal generation device 3 of the waveform signal generation system 1. Therefore, the waveform signal generation system 1 exemplified in FIG. 1 does not include the waveform signal generation device 4.

In the second stage, the waveform signal generation device 4 restores the voice waveform signal (original voice waveform signal) input to the intermediate representation prediction device 2 based on the intermediate representation signal (mel spectrogram) input from the intermediate representation prediction device 2.

In the first stage, when the mel spectrogram is estimated based on the original voice waveform signal, the information is removed in the foregoing “S2”, the information is compressed in the foregoing “S3”, and a part of the information of the original voice waveform signal is eliminated. Therefore, it is not easy to restore the original voice waveform signal (to generate the target waveform signal) merely by using simple signal processing.

Accordingly, in the learning stage of the trained model, a large number of pieces of pair data “(x, s)” of the voice waveform signal “x” and the mel spectrogram “s” are prepared. The trained model learns the neural network function unit 40 serving as a transformer from the mel spectrogram “s” to the voice waveform signal “x” through data-driven using the pair data “(x, s)”.

The neural network function unit 40 has a neural network that has high representation capability. The neural network function unit 40 includes, for example, an autoregressive model that has a neural network. The autoregressive model includes, for example, a recurrent neural network (RNN) or a causal convolutional neural network.

The neural network function unit 40 may include a flow model that has a neural network. The neural network function unit 40 may include a diffusion probabilistic model that has a neural network. The neural network function unit 40 may include a variational autoencoder that has a neural network.

The neural network function unit 40 may include a trained model for performing a scheme based on a hostile generation network. In the scheme based on the hostile generation network, a 1-dimensional convolutional neural network (1D CNN) is often used. The size of the trained model of the 1-dimensional convolution neural network is small. The neural network function unit 40 may perform estimation processing in parallel using the trained model of the 1-dimensional convolution neural network.

In the scheme based on the hostile generation network, for example, a 2-dimensional convolutional neural network (2D CNN) or a recurrent neural network may be used. Hereinafter, the neural network function unit includes, for example, a 1-dimensional convolutional neural network.

Since the frequency direction is regarded as a dimension of the feature, the neural network function unit 40 performs convolution in the time direction using a 1-dimensional convolution neural network. The mel spectrogram is obtained by scale-transforming an amplitude spectrogram obtained by applying a short-time Fourier transform to a voice waveform signal. Therefore, the time direction of the mel spectrogram is downsampled as compared with the time direction of the voice signal.

Accordingly, the neural network function unit 40 performs processing opposite to the processing for extracting the mel spectrogram. For example, the neural network function unit 40 performs upsampling in the time direction. In general, upsampling of about several hundred times is performed, but it is difficult to perform upsampling of about hundreds of times at a time in sufficient consideration of a relationship between the voice waveform signal and frames adjacent in the time direction.

Therefore, as exemplified in FIG. 2, a neural network for performing upsampling in multiple stages is often used. In FIG. 2, the neural network function unit 40 performs upsampling a of, for example, 256 (=8×8×2×2) times. This upsampling is implemented by a 1-dimensional convolution neural network of the neural network function unit 40.

An input layer 301 is a convolution layer (input conv) of an input stage (the frontmost stage). An intermediate representation signal (mel spectrogram) is input from the intermediate representation prediction device 2 to the input layer 301. The input layer 301 outputs the intermediate representation signal input from the intermediate representation prediction device 2 to the first resolution change unit 302.

The first resolution change unit 302 (ResBlock) includes an upsampling layer of 8 times and a convolution layer with residual connection. The first resolution change unit 302 performs the upsampling of 8 times in the time direction with respect to an output of the input layer 301 by using the upsampling layer of 8 times. The first resolution change unit 302 uses the convolution layer with residual connection to perform convolution processing on an output of an upsampling layer of 8 times. Accordingly, a time resolution of the intermediate representation signal is transformed.

A second resolution change unit 303 (ResBlock) includes an upsampling layer of 8 times and a convolution layer with residual connection. The second resolution change unit 303 uses the upsampling layer of 8 times to perform the upsampling of 8 times with respect to the output of the first resolution change unit 302. The second resolution change unit 303 uses the convolution layer with residual connection to perform convolution processing on the output of the upsampling layer of 8 times.

A third resolution change unit 304 (ResBlock) includes an upsampling layer of 2 times and a convolution layer with residual connection. The third resolution change unit 304 uses the upsampling layer of 2 times to perform upsampling of 2 times with respect to the output of the second resolution change unit 303. The third resolution change unit 304 uses the convolution layer with residual connection to perform convolution processing on the output of the upsampling layer of 2 times.

A fourth resolution change unit 305 (ResBlock) includes an upsampling layer of 2 times and a convolution layer with residual connection. The fourth resolution change unit 305 uses the upsampling layer of 2 times to perform upsampling of 2 times on the output of the third resolution change unit 304.

The fourth resolution change unit 305 executes convolution processing on the output of the an upsampling layer of 2 times by using the convolution layer having residual connection.

The output layer 306 is a convolution layer (output conv) of the output stage (the rearmost stage). An intermediate representation signal (mel spectrogram) subjected to upsampling of 256 times and convolution processing is input to the output layer 306 from the fourth resolution change unit 305. The output layer 306 outputs the intermediate representation signal subjected to upsampling of 256 times and convolution processing to a predetermined information processing device (not illustrated) as a target waveform signal.

The neural network function unit 40 may perform upsampling of three stages of “256=8×8×4” instead of performing upsampling of 4 stages. The neural network function unit 40 may perform the upsampling at multiple stages at magnification (division number) other than “256=8×8×2×2” and “256=8×8×4”.

The neural network function unit 40 may include a convolution layer with no residual connection. Some or all of the layers of the neural network function unit 40 may include a neural network other than a convolutional neural network. The neural network other than the convolutional neural network is, for example, a recurrent neural network and a fully-connected neural network (FNN).

A trained model of the neural network function unit 40 learns using the scheme based on the hostile generation network. In the scheme based on the hostile generation network, each hostile loss function exemplified in Formulae (1) and (2) is used.

$$\begin{matrix}[ Math . 1 ] & \\ {ℒ}_{a d v} ( D ; G ) = {𝔼}_{( x , s )} [ {( D ( X ) - 1 )}^{2} + {( D ( G ( s ) ) )}^{2} ] & ( 1 )\end{matrix}$$

$$\begin{matrix}[ Math . 2 ] & \\ {ℒ}_{a d v} ( G ; D ) = {𝔼}_{s} [ {( D ( G ( s ) - 1 ) )}^{2} ] & ( 2 )\end{matrix}$$

Here, “G(s)” indicates a voice waveform signal generated by a waveform signal generation device (voice signal generation device) “G”. “D (x)” indicates an output of a discriminator “D” discriminating whether a voice waveform signal is real (an original waveform signal) or false (a generated voice waveform signal).

The hostile loss function may not be limited to a loss function based on “least squares GAN (LSGAN)” or may be a hostile loss function based on any distance measure. For example, the hostile loss function may be a loss function based on “Wasserstein GAN” or a loss function based on “Non-saturating GAN”.

The discriminator “D” minimizes a hostile loss function “L_{adv} (D; G)” of Formula (1) so that a real voice waveform signal “x” and a false voice waveform signal “G(s)” differ as much as possible. On the other hand, the waveform signal generation device “G” minimizes a hostile loss function “L_{adv} (G; D)” of Formula (2) so that the generated sound waveform signal “G(s)” and the real sound waveform signal “x” are equal as much as possible.

In this way, the target waveform signal is optimized under the condition that the discriminator “D” that causes the real voice waveform signal and the false voice waveform signal to become different from each other and the waveform signal generation device “G” that causes the real voice waveform signal and the false voice waveform signal to become equal to each other compete with each other. Through this optimization, the waveform signal generation device “G” finally generates a target waveform signal (voice waveform signal) in which the discriminator “D” cannot discriminate whether the signal is a real voice waveform signal or a false voice waveform signal.

For stabilization of learning, a hostile loss function and a mel spectrogram loss function may be used. The mel spectrogram loss function “Lₘₑₗ (G)” is represented by Formula (3).

$$\begin{matrix}[ Math . 3 ] & \\ {ℒ}_{mel} ( G ) = {𝔼}_{( x , s )} [ {‖ ϕ ( x ) - ϕ ( G ( S ) ) ‖}_{1} ] & ( 3 )\end{matrix}$$

Here, “φ” indicates a function of extracting a mel spectrogram from a voice waveform signal. “φ” may be a function based on any signal processing (specifically, time-frequency transformation based on a predetermined basis function, or linear transformation of the time-frequency transformation, or the like). The function based on any signal processing is, for example, a spectrogram, cepstrum, or mel cepstrum extraction function, or the like “φ” may be any predetermined function. The predetermined function is, for example, a neural network function. In Formula (3), any distance measure is used. For example, in Formula (3), a distance L1 is used as a distance measure, but the distance measure may be a distance L2 or a Wasserstein distance.

By using the Mel spectrogram loss function “Lₘₑₗ (G)”, the generated sound waveform signal “G(s)” and the target waveform signal “x” can be brought close to each other based on the Mel spectrogram.

For the stabilization of learning, a hostile loss function, a mel spectrogram loss function and a feature adaptive loss function may be used. The feature adaptive loss function “L_{fm} (G; D)” is expressed as in Formula (4).

$$\begin{matrix}[ Math . 4 ] & \\ {ℒ}_{f m} ( G , D ) = {𝔼}_{( x , s )} [ {\sum }_{i = 1}^{T} \frac{1}{{N}_{i}} {‖ {D}^{i} ( X ) - {D}^{i} ( G ( s ) ) ‖}_{1} ] & ( 4 )\end{matrix}$$

Here, “T” indicates the number of layers of the discriminator “D”. “Dⁱ” indicates a feature of an i-th layer of the discriminator “D”. “Nⁱ” indicates the number of features of the i-th layer of the discriminator “D”. In Formula (4), any distance measure is used. For example, in Formula (4), the distance L1 is used as a distance measure, but the distance measure may be the distance L2 or a Wasserstein distance.

In Formula (4), features of all the layers in the discriminator “D” are taken into consideration, but the features of only some layers in the discriminator “D” may be taken into consideration. By using the feature adaptive loss function “L_{fm} (G; D)”, the generated voice waveform signal “G(s)” and the target waveform signal “x” can be brought close to each other within the feature space of the discriminator “D”.

A final loss function in which the hostile loss function “L_{adv} (D; G)”, the mel spectrogram loss function “Lₘₑₗ (G)” and the feature adaptive loss function “L_{fm} (G; D)” are combined is expressed as in Formulae (5) and (6).

$$\begin{matrix}[ Math . 5 ] & \\ {ℒ}_{G} = {ℒ}_{a d v} ( G ; D ) + {λ}_{fm} {ℒ}_{fm} ( G ; D ) + {λ}_{mel} {ℒ}_{mel} ( G ) & ( 5 )\end{matrix}$$

$$\begin{matrix}[ Math . 6 ] & \\ {ℒ}_{D} = {ℒ}_{adv} ( D ; G ) & ( 6 )\end{matrix}$$

Here, “λ_{fm}” is a weighting parameter of the feature adaptive loss function. “λₘₑₗ” is a weighting parameter of the mel spectrogram loss function. The waveform signal generation device (voice signal generator) “G” is optimized by minimizing “L_{G}” shown in Formula (5). The discriminator “D” is optimized by minimizing the “L_{D}” shown in Formula (5).

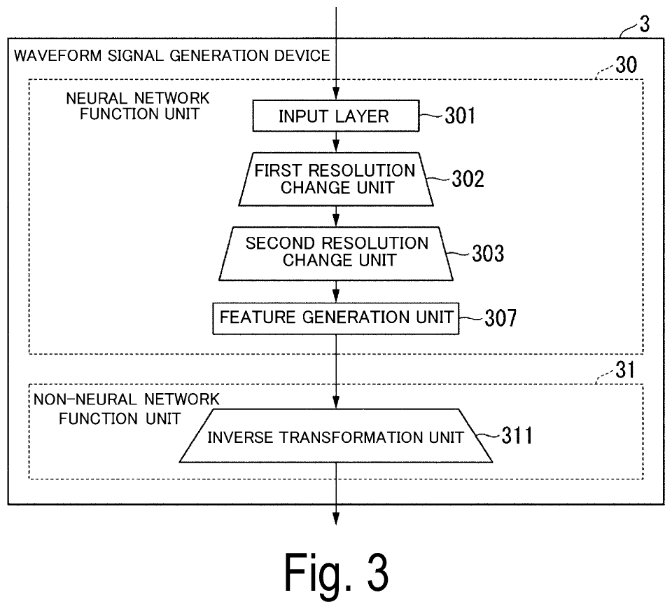

FIG. 3 is a diagram illustrating a configuration example of the waveform signal generation device 3 according to the embodiment. The waveform signal generation device 3 includes a neural network function unit 30 and a non-neural network function unit 31. The neural network function unit 30 includes an input layer 301, a first resolution change unit 302, a second resolution change unit 303, and a feature generation unit 307. The non-neural network function unit 31 includes an inverse transformation unit 311.

The neural network function unit 30 (voice signal generator) has a neural network with high representation capability. The neural network function unit 30 includes, for example, an autoregressive model that has a neural network. The autoregressive model includes, for example, a recurrent neural network or a causal convolution neural network.

The neural network function unit 30 may include a flow model that has a neural network. The neural network function unit 30 may include a diffusion probability model that has a neural network. The neural network function unit 30 may include a variational autoencoder that has a neural network. The neural network function unit 30 may include a trained model that performs a scheme based on a hostile generation network.

The waveform signal generation device 4 illustrated in FIG. 2 performs all the transformation processing from an intermediate representation to a voice waveform signal as black box processing using a neural network. Accordingly, in the waveform signal generation device 3, a part of such black box processing is replaced in advance with the non-neural network function unit 31. The non-neural network function unit 31 performs predetermined signal processing (for example, a frequency-time transformation based on a predetermined basis function such as an inverse short-time Fourier transform or an inverse wavelet transform) with no learning parameters. Accordingly, since items required to be learned in the neural network are simplified, a reduction in a weight of the model and an increase in a processing speed are implemented.

When an intermediate representation signal (mel spectrogram) is input to the waveform signal generation device 3, a hybrid model of signal processing (the neural network function unit 30 and the non-neural network function unit 31) generates a voice waveform signal based on the intermediate representation signal.

The input layer 301 of the neural network function unit 30, the first resolution change unit 302 and the second resolution change unit 303 are similar to those of the input layer 301, the first resolution change unit 302, and the second resolution change unit 303 of the neural network function unit 40 exemplified in FIG. 2.

The feature generation unit 307 (output conv) generates features (amplitude spectrogram and phase spectrogram) from an output of the second resolution change unit 303 (results of the upsampling and the convolution processing at the front stage of the feature generation unit 307).

The inverse transformation unit 311 applies an inverse transform (inverse short-time Fourier transform) of the short-time Fourier transform performed by the feature transformation unit 20 to the feature generated by the feature generation unit 307. Here, in the short-time Fourier transform in the feature transformation unit 20 and the inverse short-time Fourier transform by the inverse transformation unit 311, parameters (for example, a size, a window width, and a shift width of fast Fourier transform) are different from each other. Therefore, the inverse transform of the short-time Fourier transform performed by the feature transformation unit 20 may not be performed strictly. The inverse transformation unit 311 performs upsampling of 4 times in the time direction.

In the waveform signal generation device 3, as an example, two resolution change units (the third resolution change unit 304 and the fourth resolution change unit 305) in the neural network function unit 40 exemplified in FIG. 2 are replaced in advance with the non-neural network function unit 31. A replacement mode may be not limited thereto. For example, in the waveform signal generation device 3, one, three, or four resolution change units (layers) in the neural network function unit 40 may be replaced in advance with the non-neural network function unit 31. In the waveform signal generation device 3, a resolution change unit (layer) at any position other than the rear stage (the front stage or a middle stage) in the neural network function unit 40 may be replaced in advance with the non-neural network function unit 31.

Any disposition order (signal processing order) of the neural network function unit 30 and the non-neural network function unit 31, any number of times the neural network function unit 30 is used, and any number of times the non-neural network function unit 31 is used can be used. For example, as exemplified in FIG. 3, the neural network function unit 30 and the non-neural network function unit 31 may be disposed in the order of the neural network function unit 30 and the non-neural network function unit 31. The neural network function unit 30 and the non-neural network function unit 31 may be disposed in the order of the non-neural network function unit 31 and the neural network function unit 30, or the neural network function unit 30-1, the non-neural network function unit 31, and the neural network function unit 30-2 may be disposed in this order.

In the waveform signal generation device 3, upsampling divided into stages other than four stages may be performed. The upsampling may be performed at any magnification other than 256 times. Under such conditions, the replacement processing to the non-neural network function unit 31 may be performed in advance.

The neural network function unit 30 may include a convolution layer with residual connection or a convolution layer with no residual connection. Some or all of the layers of the neural network function unit 30 may include a neural network other than a convolutional neural network. The neural network other than the convolutional neural network is, for example, a recurrent neural network and a fully-connected neural network.

When a mel spectrogram (logarithmic mel spectrogram) transformed in a logarithmic scale is used as an intermediate representation signal, the feature generation unit 307 may generate an amplitude spectrogram using an exponential function (exp). Accordingly, the mel spectrogram may explicitly be transformed from a logarithmic scale to a linear scale. When another intermediate representation signal is used, similar processing may be used.

The feature generation unit 307 may generate a phase spectrogram using a periodic function such as “sin” and “cos”. Accordingly, the periodicity of the phase spectrogram is expressed.

The feature obtained by performed the short-time Fourier transform by the feature transformation unit 20 is, for example, a spectrogram, a mel spectrogram, a cepstrum, a mel cepstrum, or a result obtained by transforming this into any function.

When a feature obtained by performing the short-time Fourier transform by the feature transformation unit 20 is used as an intermediate representation signal, the inverse transformation unit 311 determines an “FFT size” which is one of the parameters of the inverse short-time Fourier transform for executing the upsampling of “s” times in advance as, for example, “fₛ=f₁/s”. A “shift width” which is one of the parameters is determined in advance as “hₛ=h₁/s”. A “window width” which is one of the parameters is determined in advance as “wₛ=w₁/s”.

Here, “f₁” indicates an “FFT size” which is one of the parameters of the short-time Fourier transform performed by the feature transformation unit 20. “h₁” indicates a “shift width” which is one of the parameters of the short-time Fourier transform performed by the feature transformation unit 20. “w₁” indicates “window width” which is one of the parameters of the short-time Fourier transform executed by the feature transformation unit 20.

The waveform signal generation device 3 can perform learning using a loss function (for example, a loss function “L_{G}” exemplified in Formula (5)) of a scheme based on a hostile generation network. For the stabilization of learning, at least one of the hostile loss function, the mel spectrogram loss function, and the feature adaptive loss function may be used.

The non-neural network function unit 31 may be embedded in a learning model of any voice waveform signal generation scheme such as a scheme based on an autoregressive model, a scheme based on a flow model, a scheme based on a diffusion probability model, or a scheme based on a variational autoencoder. In this case, some resolution change units (layers) in the neural network function unit 40 prepared according to each scheme is replaced in advance with the non-neural network function unit 31. Further, in the learning stage, waveform signal generation device 3 performs learning using at least one of the scheme based on the flow model, the scheme based on the diffusion probability model, the variational autoencoder, and each loss function of a scheme based on a hostile generation network.

The inverse transformation unit 311 performs signal processing using a function indicating a relationship between a feature component (for example, a frequency component) and a time component as predetermined signal processing. For example, the inverse transformation unit 311 performs frequency-time transformation based on a predetermined basis function such as an inverse short-time Fourier transform or an inverse wavelet transform. Accordingly, since the items required to be learned in the neural network are simplified, a reduction in a weight of the trained model and an increase in a processing speed are implemented.

The waveform signal generation system 1 may generate a target waveform signal (voice waveform signal) using an end-to-end model that performs a process in which the first and second stages are integrated. In this case, even when the intermediate representation signal is changed for each learning step in the learning stage, a hybrid trained model of the neural network function unit 30 and the non-neural network function unit 31 is used. Therefore, the waveform signal generation device 3 can absorb such a change in the intermediate representation signal.

The target waveform signal may not be limited to the voice waveform signal. For example, the target waveform signal may be any waveform signal (time-series signal) such as a music signal or sensor data.

Next, an operation example of the waveform signal generation system 1 will be described.

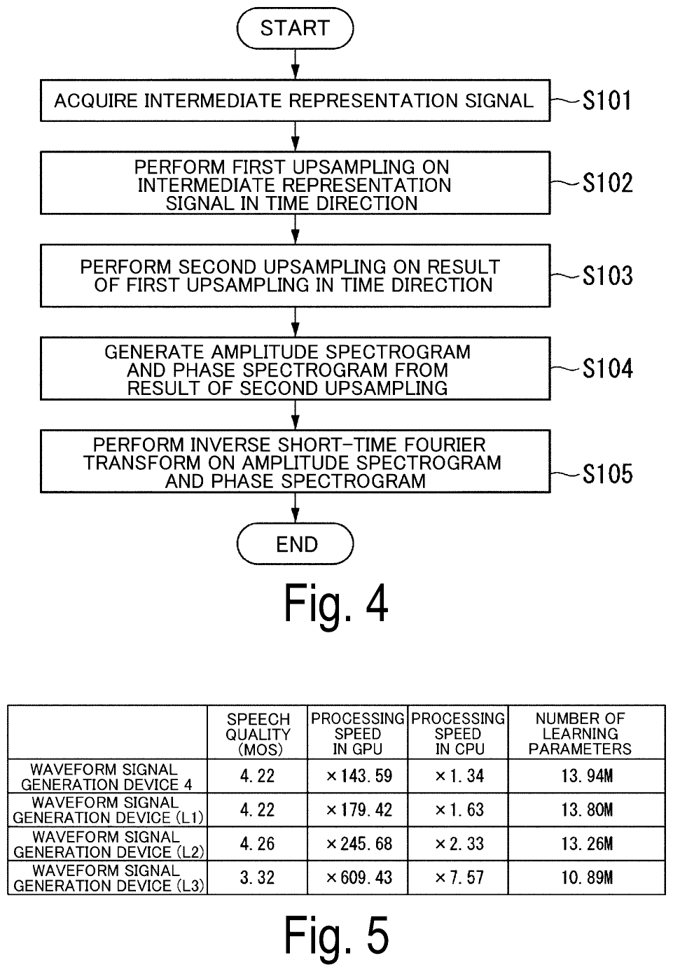

FIG. 4 is a flowchart illustrating an operation example of the waveform signal generation device 3 according to the embodiment. The input layer 301 acquires an intermediate representation signal from the intermediate representation prediction device 2 (step S101). The first resolution change unit 302 performs first upsampling in the time direction on the intermediate representation signal output from the input layer 301. The first resolution change unit 302 may perform convolution processing (step S102). The second resolution change unit 303 performs second upsampling in the time direction on a result of the first upsampling. The second resolution change unit 303 may perform convolution processing (step S103).

The feature generation unit 307 generates an amplitude spectrogram and a phase spectrogram from the result of the second upsampling (step S104). The inverse transformation unit 311 performs an inverse short-time Fourier transform on the amplitude spectrogram and the phase spectrogram (step S105).

As described above, the neural network function unit 30 changes a time resolution (time component) of the intermediate representation signal indicating an intermediate representation between the original waveform signal and the target waveform signal using the neural network function. The neural network function unit 30 upsamples the time component of the intermediate representation signal using the neural network function. The non-neural network function unit 31 generates a target waveform signal from the intermediate representation signal of which a time resolution is changed by the neural network function unit 30 by using the non-neural network function indicating a relationship between the time component and the feature component of the intermediate representation signal. All the upsampling may be performed by, for example, the neural network function unit 30 or may be executed by, for example, the non-neural network function unit 31.

In the above description, the case where the input signal is a waveform signal or text has been described, but any type of input signal can be used and is not limited to a specific type. The input signal is a data signal of a predetermined type and may be, for example, an image signal or a combination of a plurality of types (for example, image and text) of data signals.

The neural network function unit 30 generates the target waveform signal from the intermediate representation signal by changing, using the neural network function, a time component or a feature component of the intermediate representation signal indicating an intermediate representation between an input signal (for example, an input waveform signal such as an input voice signal (input voice signal), an input image signal, or an input text signal) and a target waveform signal (output signal). The non-neural network function unit 31 uses the non-neural network function indicating a relationship between the time component and the feature component of the intermediate representation signal to act for at least a part of processing for generating the target waveform signal from the intermediate representation signal. The target waveform signal (output signal) is, for example, an output waveform signal such as the target acoustic signal (target sound signal), the target image signal, or the target text signal.

Accordingly, when the target waveform signal is generated from the intermediate representation signal using the trained model that has the neural network, it is possible to reduce a weight or increase a speed of the trained model in advance.

### Effect Examples

In the following experiment (hereinafter referred to as a “present experiment”), a voice waveform signal of a speaker (woman) is used as learning data. A time length of the voice waveform signal is, for example, about 24 hours. A sampling frequency of the voice waveform signal is, for example, 22.05 kHz. In the following description, an 80-dimensional logarithmic mel spectrogram obtained by applying a short-time Fourier transform to such a voice waveform signal is used as an intermediate representation signal.

Parameters of the short-time Fourier transform are, for example, an FFT size of “1024”, a shift width of “256”, and a window width of “1024”. In the present experiment, the waveform signal generation device 3 generates a voice waveform signal (target waveform signal) with 22.05 kHz from 80-dimensional logarithmic mel spectrogram.

In this experiment, the waveform signal generation device 3 and the waveform signal generation device 4 perform a scheme based on a hostile generation network. The inverse transformation unit 311 performs an inverse short-time Fourier transform.

FIG. 5 is a diagram illustrating an effect example of the waveform signal generation device 3 according to the embodiment. A “waveform signal generation device (L1)” is a waveform signal generation device in which one resolution change unit (one layer) on an output side is replaced. That is, in the “waveform signal generation device (L1)”, one resolution change unit (the fourth resolution change unit 305) on the output side of the neural network function unit 40 exemplified in FIG. 2 is replaced in advance with the non-neural network function unit.

The “waveform signal generation device (L2)” is the waveform signal generation device 3 exemplified in FIG. 3 in which two resolution change units (two layers) on the output side are replaced. That is, in the “waveform signal generation device (L2)”, two resolution change units (the third resolution change unit 304 and the fourth resolution change unit 305) on the output side of the neural network function unit 40 exemplified in FIG. 2 are replaced in advance with the non-neural network function unit 31.

The “waveform signal generation device (L3)” is a waveform signal generation device in which three resolution change units (three layers) on the output side are replaced. That is, in the “waveform signal generation device (L2)”, three resolution change units (the second resolution change unit 303, the third resolution change unit 304 and the fourth resolution change unit 305) on the output side of the neural network function unit 40 exemplified in FIG. 2 are replaced in advance with the non-neural network function unit.

Evaluation of speech quality is subjective evaluation, and specifically, subjective evaluation based on a mean opinion score (MOS) test. The number of stages of the mean opinion scores is 5. A score of the best evaluation is “5” and a score of the worse evaluation is “1”. That is, the larger the value of the average opinion score, the better the speech quality is.

A value of a processing speed indicates a relative value to a reference speed when a reproduction speed of the voice waveform signal is used as the reference speed. In the evaluation of the processing speed, both a GPU and a CPU are used. The processing speed with a value greater than 1 indicates that signal processing can be performed faster than real time. The larger the value of the processing speed is, the faster the processing speed is.

Evaluation of a size of the trained model was evaluation based on the number of learning parameters of the neural network. The smaller the number of learning parameters is, the smaller the size of the trained model is.

For the speech quality (MOS), the “waveform signal generation device (L1)” and the “waveform signal generation device (L2)” are equivalent to the waveform signal generation device 4. The “waveform signal generation device (L3)” is inferior to the waveform signal generation device 4 exemplified in FIG. 2.

The processing speed in the GPU and the processing speed in the CPU are faster in the order of the “waveform signal generation device (L3)”, the “waveform signal generation device (L2)”, the “waveform signal generation device (L1)”, and the “waveform signal generation device 4”. Accordingly, the processing speed of the waveform signal generation device is faster as the number of the transformation units (layers) replaced in advance is larger when the waveform signal generation device 4 is used as a reference.

The number of learning parameters is less in the order of the “waveform signal generation device (L3)”, the “waveform signal generation device (L2)”, the “waveform signal generation device (L1)”, and the “waveform signal generation device 4”. That is, the size of the trained model is smaller in this order. Therefore, the more the number of transformation units (layers) to be replaced is, the smaller the size of the trained model is.

In this way, when the number of the transformation units replaced in advance is 2 or less, speech quality of the “waveform signal generation device (L3)”, the “waveform signal generation device (L2)” and the “waveform signal generation device (L1)” is equal to that of the “waveform signal generation device 4”. The processing speed and the size of the trained model of the “waveform signal generation device (L3)”, the “waveform signal generation device (L2)” and the “waveform signal generation device (L1)” are improved more than those of the “waveform signal generation device 4”.

The result of the experiment shows that the processing speed can be increased and the size of the trained model can be reduced (the weight of the trained model is reduced), while maintaining the speech quality at a certain level or higher, by appropriately selecting the number and position of the layers to be replaced in the neural network function unit.

### (Hardware Configuration Example)

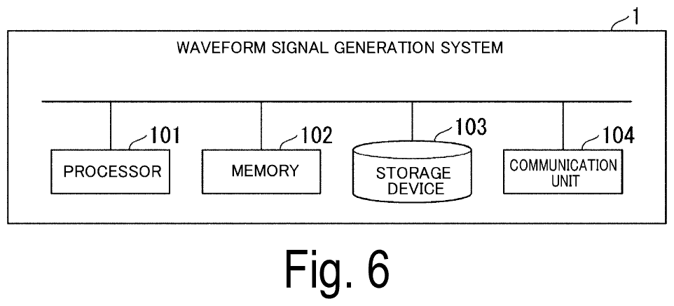

FIG. 6 is a diagram illustrating a hardware configuration example of the waveform signal generation system 1 according to an embodiment. Some or all of the functional units of the waveform signal generation system 1 are implemented as software by a processor 101 such as a central processing unit (CPU) executing a program stored in the storage device 103 that has a nonvolatile recording medium (non-transitory recording medium) and a memory 102. The program may be recorded in a computer-readable non-transitory recording medium. Examples of the computer-readable non-transitory recording medium include a portable medium such as a flexible disc, a magneto-optical disc, a read only memory (ROM), or a compact disc read only memory (CD-ROM), and a non-transitory recording medium such as a storage device including a hard disk or solid state drive (SSD) built in a computer system. The communication unit 104 perform predetermined communication processing. The communication unit 104 may acquire a program and data such as a voice waveform signal.

Some or all of the functional units of the waveform signal generation system 1 may be implemented using hardware including an electronic circuit or circuitry using, for example, a large scale integrated circuit (LSI), an application specific integrated circuit (ASIC), a programmable logic device (PLD), or a field programmable gate array (FPGA).

Although the embodiments of the present invention have been described in detail with reference to the drawings, specific configurations are not limited to the embodiments, and design within the scope of the gist of the present invention and the like are included.

### INDUSTRIAL APPLICABILITY

The present invention can be applied to machine learning and a signal processing system generating a voice waveform signal.

### REFERENCE SIGNS LIST

1 Waveform signal generation system
2 Intermediate representation prediction device
3 Waveform signal generation device
4 Waveform signal generation device
20 Feature transformation unit
21 Intermediate representation transformation unit
30 Neural network function unit
31 Non-neural network function unit
40 Neural network function unit
101 Processor
102 Memory
103 Storage device
104 Communication unit
301 Input layer
302 First resolution change unit
303 Second resolution change unit
304 Third resolution change unit
305 Fourth resolution change unit
306 Output layer
307 Feature generation unit
311 Inverse transformation unit

1. A waveform signal generation system comprising:
a neural network configured to generate a target waveform signal from an intermediate representation signal by changing a time component or a feature component of the intermediate representation signal indicating an intermediate representation between an input signal and the target waveform signal using a neural network function; and
a non-neural network configured to act for at least a part of processing for generating the target waveform signal from the intermediate representation signal using a non-neural network function indicating a relationship between the time component and the feature component of the intermediate representation signal.

2. The waveform signal generation system according to claim 1, wherein the neural network performs upsampling of a time component of the intermediate representation signal using the neural network function.

3. The waveform signal generation system according to claim 1, wherein the neural network is a convolutional neural network.

4. The waveform signal generation system according to claim 1, wherein the non-neural network generates the target waveform signal from the intermediate representation signal of which the time component is changed by the neural network.

5. The waveform signal generation system according to claim 1, wherein the non-neural network performs frequency-time transformation based on an inverse short-time Fourier transform, an inverse wavelet transform, or a predetermined basis function on the intermediate representation signal.

6. A waveform signal generation method executed by a waveform signal generation system, the method comprising:
generating a target waveform signal from an intermediate representation signal by changing a time component or a feature component of the intermediate representation signal indicating an intermediate representation between an input signal and the target waveform signal using a neural network function; and
acting for at least a part of processing for generating the target waveform signal from the intermediate representation signal using a non-neural network function indicating a relationship between the time component and the feature component of the intermediate representation signal.

7. A non-transitory computer readable medium which stores a program causing a computer to function as the waveform signal generation system according to claim 1.
